(19) United States
(12) Patent Application Publication
(10) Pub. No.: US 2023/0111789 A1
(43) Pub. Date: Apr. 13, 2023

(54) FLAVORED ALCOHOLIC BEVERAGES AND A METHOD OF PREPARING THEREOF

(71) Applicants: Scott McCullough, Playa del Rey, CA (US); Amira Hashim, Playa del Rey, CA (US)

(72) Inventors: Scott McCullough, Playa del Rey, CA (US); Amira Hashim, Playa del Rey, CA (US)

(21) Appl. No.: 17/499,270

(22) Filed: Oct. 12, 2021

(51) Int. Cl. C12G 3/06

(52) U.S. Cl. CPC C12G 3/06

(57) ABSTRACT

An alcoholic beverage, such as Vodka that includes a singular natural additive infused with neutral spirits and treated water. The natural additive is rose water.

### FIELD OF INVENTION

The present invention relates to alcoholic beverages and more particularly, the present invention relates to rose water-infused alcoholic beverages and a method of preparing the same.

### BACKGROUND

Vodka is the most popular and versatile alcoholic beverage in the world of spirits. Most of the varieties of vodka commercially available are flavored and the popularity of flavored vodkas is still on the rise. However, the known flavored vodkas are made from artificial flavors that resemble or imitate natural flavors. The use of chemical flavors reduces the cost of the entire manufacturing process, reduces process time, and makes it easier to blend due to the absence of natural ingredients. However, a trade-off exists in that the taste of flavored Vodkas that have been prepared using chemical flavors is inferior to the taste of infused vodkas that have been prepared using natural ingredients. Thus, a desire is there for a naturally infused vodka with unique flavors that are liked by most spirits lovers.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a method for producing flavored singular, isolated and additive vodka from natural ingredients.

It is another object of the present invention that the flavored vodka has no chemical additives.

It is still another object of the present invention that the flavored vodka has no additive sugars.

In one aspect, disclosed is a flavored vodka that includes rose water as the only additive and does not contain any chemical additives, preservatives, or sugars.

In one aspect, rose water can be obtained by a single variety of roses or from two or more varieties of roses.

In one aspect, the water treated with granulated charcoal (coconut husk) for up to 72 h can be used in the manufacture.

In one aspect, corn, grapes, wheat, potato, grains, and agave-based alcohols can also be used alone or in combination with corn-based alcohols.

In one aspect, the rosewater extract/distillate, such as from Damascena Roses can be used as a natural flavor infusing ingredient in the manufacturing.

In one aspect, the disclosed invention can also be directed to the manufacture of rose-flavored gin and tequila.

In one aspect, the flavored vodka is about 80 proof (40% ABV), or preferably 38-43% ABV.

In one aspect, the flavored vodka has a pH in the range of about 5-8.

In one aspect, the disclosed flavored vodka is “true original”, “one of a kind”, and “deserving its own classification” from established industry professional organizations.

These and other objects and advantages of the embodiments herein and the summary will become readily apparent from the following detailed description.

### DETAILED DESCRIPTION

Subject matter will now be described more fully hereinafter with reference to specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Unless otherwise indicated, all numbers expressing quantities of ingredients used in this disclosure are to be understood as being modified in all instances by the term “about.” Accordingly, unless indicated to the contrary, the numerical parameters set forth in this disclosure are approximations that may vary depending upon the desired properties sought to be obtained by the present disclosure. At the very least, and not as an attempt to limit the application of the doctrine of equivalents to the scope of any claims, each numerical parameter should be construed in light of the number of significant digits and ordinary rounding approaches.

Disclosed are flavored alcoholic beverages and a method of production thereof. The flavored alcoholic beverages can include Vodka, Gin, Tequila, and like. The disclosed alcoholic beverages can be unique having only a singular natural additive that can be infused for natural and enhanced flavor and aroma. The flavored alcoholic beverage can be made from neutral spirits, treated water, and rose water. The neutral spirits can be obtained from grains, grapes, potato, wheat, agave, and like spirits. Preferably, the neutral spirits can be corn neutral grain spirits (NGS), however, any other spirit is within the scope of the present invention. The water used in the disclosed alcoholic beverages can be treated with charcoal for a predetermined duration, such as much as 72 hours.

The rose water can be obtained from varieties of roses and may be obtained from single or multiple varieties of roses. Preferably, the rose water can be obtained from Damascena Roses, Bulgaria. Rose water can be prepared from rose petals using steam distillation. The essential oils may not be separated from the water.

### Experimental Details

Rosewater was obtained from Damascena Roses' petals. The rose water was transparent and colorless liquid. The odor resembled typical rose flowers. Rose Oil remnants typically found in rose water were less than 0.5%.

In one example, 0 to 10% of rose was integrated with corn NGS and treated water to obtain a singular and isolated additive vodka. The pH of the flavored vodka was between 5.0-8.0. Analysis by Gas chromatography of rose water revealed macro compounds including phenyl ethyl alcohol, Citronellol, Geraniol, and Nerol.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

1. An alcoholic beverage which is Vodka consisting of:
spirits;
water; and
rose water obtained from distillation of a selected variety of rose,
wherein the Vodka comprises 38-43% alcohol by volume, wherein the Vodka has a pH of about 5-8, wherein the water is water treated for up to 72 h with charcoal.

2. The alcoholic beverage according to claim 1, wherein the spirits are corn neutral grain spirits.

3. (canceled)

4. The alcoholic beverage according to claim 1, wherein the rose water is obtained from Damascena Roses.

5. (canceled)

6. (canceled)

7. (canceled)

8. A method for producing Vodka, the method consists of the steps:
obtaining rose water from distillation of a selected variety of rose,
adding together water, the rose water, and spirits to obtain Vodka,
wherein the water is water treated for up to 72 h with charcoal,
wherein the Vodka comprises 38-43% alcohol by volume,
wherein the Vodka has a pH of about 5-8.

9. The method according to claim 8, wherein the spirits are corn neutral grain spirits.

10. (canceled)

11. The method according to claim 8, wherein the rose water is obtained from Damascena Roses.

12. (canceled)

13. (canceled)

14. (canceled)
